(19) United States
(12) Patent Application Publication
(10) Pub. No.: US 2012/0062559 A1
(43) Pub. Date: Mar. 15, 2012

(54) Method for Converting Two-Dimensional Image Into Stereo-Scopic Image, Method for Displaying Stereo-Scopic Image and Stereo-Scopic Image Display Apparatus for Performing the Method for Displaying Stereo-Scopic Image

(76) Inventors: Hae-Young Yun, Suwon-si (KR); Kyung-Ho Jung, Yongin-si (KR); Seung-Hoon Lee, Hwaseong-si (KR); Kyung-Bae Kim, Yongin-si (KR); Joo-Young Kim, Suwon-si (KR); Jin-Hwan Kim, Suwon-si (KR)

(21) Appl. No.: 13/228,687

(22) Filed: Sep. 9, 2011

(30) Foreign Application Priority Data
Sep. 10, 2010 (KR) 2010-0088639

(51) Int. Cl. G06T 15/00

(52) U.S. Cl. 345/419

(57) ABSTRACT

In a method for displaying a stereo-scopic image a border for each of multi-viewpoint images is formed around an edge of a display region, and each bordered multi-viewpoint image is converted into a synthetic image. The synthetic image is displayed as a stereo-scopic image in the display region through a lenticular lens inclined by a predetermined angle with respect to a display panel. Therefore, a two-dimensional image may be effectively converted into the stereo-scopic image decreasing saw-edged shapes at the border of the stereo-scopic image, improving display quality.

### PRIORITY STATEMENT

This application claims priority under 35 U.S.C. §119 from Korean Patent Application No. 2010-88639, filed on Sep. 10, 2010 in the Korean Intellectual Property Office (KIPO), the contents of which are herein incorporated by reference in their entirety.

### BACKGROUND OF THE INVENTION

1. Field of the Invention

Embodiments of the present invention are directed to methods for converting a two-dimensional image into a stereo-scopic image, methods for displaying the stereo-scopic image using methods for converting the two-dimensional image into the stereo-scopic image, and stereo-scopic image display apparatuses for performing the methods for displaying the stereo-scopic image. More particularly, embodiments of the present invention are directed to methods for converting a two-dimensional image into a stereo-scopic image capable of improving display quality, methods for displaying the stereo-scopic image using methods for converting the two-dimensional image into the stereo-scopic image and stereo-scopic image display apparatuses for performing the methods for displaying the stereo-scopic image.

2. Description of the Related Art

Recently, stereoscopic image display apparatuses for displaying a stereo-scopic image have been developed in response to an increase in demand for stereo-scopic images in the fields of games and movies, etc. A stereoscopic image display apparatus may be classified as either a stereoscopic type or an autostereoscopic type depending on whether the viewer is required to wear extra glasses for viewing the stereoscopic image. In general, an autostereoscopic image display apparatus that does not require the extra glasses, such as a barrier type or a lenticular type, is used in a flat panel display apparatus.

A lenticular type uses a lenticular lens with a plurality of viewpoints that emits a plurality of stereo-scopic images by refracting a two-dimensional (2D) image at the plurality of viewpoints. In a lenticular type of image display, most of the light passes through the lens, which minimizes luminance decrease as compared to the barrier type.

A lenticular lens has a rectangular or a parallelogram shape, and has a plurality of circular arcs formed on a surface of the lenticular lens and edges formed at a border portion of the circular arcs adjacent to each other. A lenticular lens concentrates light on one point by refracting the light at the circular arcs.

When a lenticular lens is inclined with respect to pixels of a display panel, a border of the display panel may be displayed as a saw-edged shape, which may degrade display quality.

In addition, in the process of converting a 2D image into a stereo-scopic image, different images should be generated at each of the viewpoints. Thus, a conventional image conversion method may involve excess calculations that could overload the conversion process.

### SUMMARY OF THE INVENTION

Exemplary embodiments of the present invention provide methods for converting a two-dimensional image into a stereo-scopic image capable of improving display quality.

Exemplary embodiments of the present invention also provide methods for displaying a stereo-scopic image using methods for converting the two-dimensional image into the stereo-scopic image.

Exemplary embodiments of the present invention also provide a stereo-scopic image display apparatus for performing methods for displaying the stereo-scopic image.

According to one aspect of the present invention, a method for converting a two-dimensional image into a stereo-scopic image is provided as follows. A border for each of multi-viewpoint images is formed around edges of a display region. The bordered multi-viewpoint images are converted into a synthetic image.

In an exemplary embodiment, the method may further include generating the plurality of the multi-viewpoint images based on a two-dimensional image and a depth image.

In an exemplary embodiment, the plurality of multi-viewpoint images may be generated by generating image values in a multi-viewpoint image grid corresponding to the display region.

In an exemplary embodiment, the border of the multi-viewpoint images may be formed around the edges of the display region by setting to black the image values in the multi-viewpoint image grid corresponding to a peripheral region surrounding the display region. In this case, image values in the multi-viewpoint image grid corresponding to one or two pixels inside from the edges of the display region toward inside may be further set to black.

In an exemplary embodiment, the border of each of the multi-viewpoint images may be formed around the edges of the display region by setting to black the image values in the multi-viewpoint image grid corresponding to one or two pixels inside from the edges of the display region.

In an exemplary embodiment, the bordered multi-viewpoint images may be converted into the synthetic image by interpolating the image values in a synthetic image grid using the four nearest image values in the multi-viewpoint image grid.

In an exemplary embodiment, the image values in the synthetic image grid may be interpolated by calculating a conversion scale and a conversion offset of the synthetic image, calculating a color number and a viewpoint number in the synthetic image grid, calculating a displacement of the synthetic image based on the conversion scale and the conversion offset of the synthetic image, and interpolating the image values in the synthetic image grid based on the displacement of the synthetic image, the color number and the viewpoint number in the synthetic image grid.

In an exemplary embodiment, the conversion scale and the conversion offset of the synthetic image may be calculated by calculating a row conversion scale according to
row_conversion_scale=number_of_rows_of_multi_viewpoint_image_grid/number_of_rows_of_synthetic_image_grid,
   and a column conversion scale according to
column_conversion_scale=number_of_columns_of_multi_viewpoint_image_grid/number_of _columns_of_synthetic_image_grid.
   Then, a row conversion offset may be calculated according to
row_conversion_offset={1−row_conversion_scale}/2,
   and a column conversion offset may be calculated according to
column_conversion_offset={1−column_conversion_scale}/2

In an exemplary embodiment, the color number and the viewpoint number in the synthetic image grid may be calculated by calculating the color number according to
color_number=mod {column_number−1, 3}+1,
   and calculating the viewpoint number according to
viewpoint_number=mod{column_number−row_number+viewpoint_offset, number_of_viewpoints}+1,

wherein mod{a, b} is a remainder from dividing ‘a’ by ‘b’ and the viewpoint offset is an integer between 1 and the number of the viewpoints.

In an exemplary embodiment, the displacement of the synthetic image may be calculated based on the conversion scale and the conversion offset of the synthetic image by calculating a row position according to
row_position=row_number×row_conversion_scale+row_conversion_offset, and a column position according to
column position=column number×column_conversion_scale+column_conversion_offset,
   and calculating a row displacement using the row position according to
row_displacement=row_position−floor{row_position},
   and a column displacement using the column position according to
column_displacement=column_position−floor{column_position},

wherein floor{c} represents a truncation of all decimal digits of ‘c’.

In an exemplary embodiment, the multi-viewpoint images may be interpolated using either bilinear interpolation or bicubic interpolation.

According to another aspect of the invention, a method for displaying a stereo-scopic image is provided as follows. A plurality of image values are interpolated using four nearest image values in a multi-viewpoint image grid to generate a synthetic image grid. The synthetic image is displayed as a stereo-scopic image in a display region through a lenticular lens inclined by a predetermined angle with respect to a display panel.

In an exemplary embodiment, the method may further include generating the plurality of image values in the multi-viewpoint image grid corresponding to the display region based on a two-dimensional image and a depth image.

In an exemplary embodiment, the image values in the synthetic image may be interpolated by calculating a conversion scale and a conversion offset of the synthetic image, calculating a color number and a viewpoint number in the synthetic image grid, calculating a displacement of the synthetic image based on the conversion scale and the conversion offset of the synthetic image, and interpolating the image values in the synthetic image grid based on the displacement of the synthetic image, the color number and the viewpoint number in the synthetic image grid.

In an exemplary embodiment, the border of the multi-viewpoint images may be formed around the edges of the display region by setting the image signals in the multi-viewpoint image grid corresponding to one or two pixels from the edges of the display region toward inside to the image signals corresponding to a black grayscale. The border for each of the plurality of multi-viewpoint images may be formed by setting to black the image values in the multi-viewpoint image grid corresponding to a peripheral region surrounding the display region, and/or setting to black the image values in the multi-viewpoint image grid corresponding to one or two pixels inside from the edges of the display region.

According to still another aspect of the present invention, a stereo-scopic image display apparatus includes a border forming part, a synthetic image part and a display panel. The border forming part forms a border for each of the multi-viewpoint images around edges of a display region. The synthetic image part converts the bordered multi-viewpoint images into a synthetic image. The display panel displays the synthetic image as a stereo-scopic image in the display region through a lenticular lens inclined by a predetermined angle.

In an exemplary embodiment, the apparatus may further include a multi-viewpoint image part for generating the plurality of the multi-viewpoint images based on a two-dimensional image and a depth image.

In an exemplary embodiment, the lenticular lens may have a parallelogram shape in which a pair of sides facing each other are substantially parallel with a side of the display panel. In this case, a width of the lenticular lens may correspond to a number of pixels of the display panel where each pixel corresponds to one of the plurality of multi-view-point images, and a plurality of the lenticular lenses may be arranged along the side of the display panel.

In an exemplary embodiment, the border forming part may set to black the image values in the multi-viewpoint image grid corresponding to a peripheral region surrounding the display region.

In an exemplary embodiment, the border forming part may set to black the image values in the multi-viewpoint image grid corresponding to one or two pixels inside from the edges of the display region.

According to still another aspect of the present invention, a stereo-scopic image display apparatus includes a synthetic image part, and a display panel. The synthetic image part interpolates a plurality of image values using four nearest image values in a multi-viewpoint image grid to generate a synthetic image grid. The display panel displays the synthetic image as a stereo-scopic image in a display region through a lenticular lens inclined by a predetermined angle. A width of the lenticular lens corresponds to a predetermined number of pixels of the display panel, each pixel corresponds to one of the plurality of multi-viewpoint images, and a plurality of the lenticular lenses are arranged along the side of the display panel.

In an exemplary embodiment, the stereo-scopic image display apparatus may further include a multi-viewpoint image part for generating the plurality of the image values in the multi-viewpoint image grid corresponding to the display region based on a two-dimensional image and a depth image.

In an exemplary embodiment, the stereo-scopic image display apparatus also includes a border forming part for forming, for each of the plurality of multi-viewpoint images, a border around an edge of the display region.

According to methods for converting the two-dimensional image into the stereo-scopic image, a stereo-scopic image is processed using interpolation, which decreases a calculating load of the stereo-scopic image display apparatus, and reduces a serrated border of the stereo-scopic image, improving display quality.

### BRIEF DESCRIPTION OF THE DRAWINGS

FIG. 1 is a block diagram illustrating a stereo-scopic image display apparatus according to an exemplary embodiment of the present invention.

FIG. 2 is a block diagram illustrating of a stereo-scopic image converting apparatus of FIG. 1.

FIG. 3 is a conceptual diagram illustrating exemplary correspondence between the pixels and the lenticular lens of FIG. 1.

FIG. 4 is a conceptual diagram illustrating an exemplary multi-viewpoint image of FIG. 3.

FIGS. 5A to 5C are conceptual diagrams illustrating pixels shown at each viewpoint, when the multi-viewpoint image of FIG. 4 is displayed.

FIG. 6 is a conceptual diagram illustrating a multi-viewpoint image grid of a multi-viewpoint image and a synthetic image grid of a synthetic image of FIG. 3.

FIG. 7 is a flow chart illustrating a method for displaying a stereo-scopic image performed by the stereo-scopic image display apparatus of FIG. 1.

FIGS. 8 and 9 are detailed flow charts illustrating steps of interpolating the multi-viewpoint images to covert the multi-viewpoint images into the synthetic image of FIG. 7.

### DETAILED DESCRIPTION OF EXEMPLARY EMBODIMENTS

Hereinafter, exemplary embodiments of the present invention will be explained in detail with reference to the accompanying drawings.

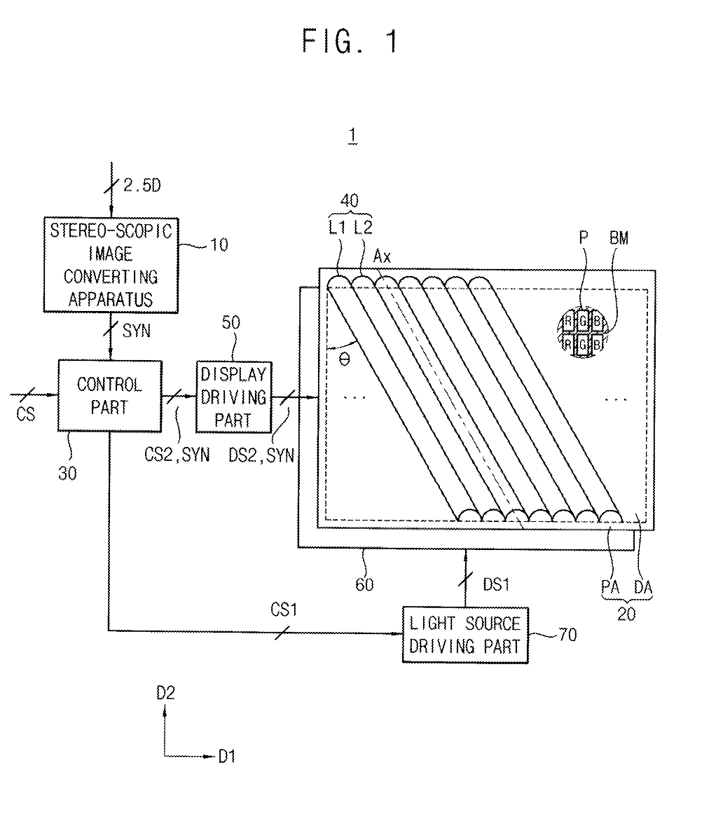

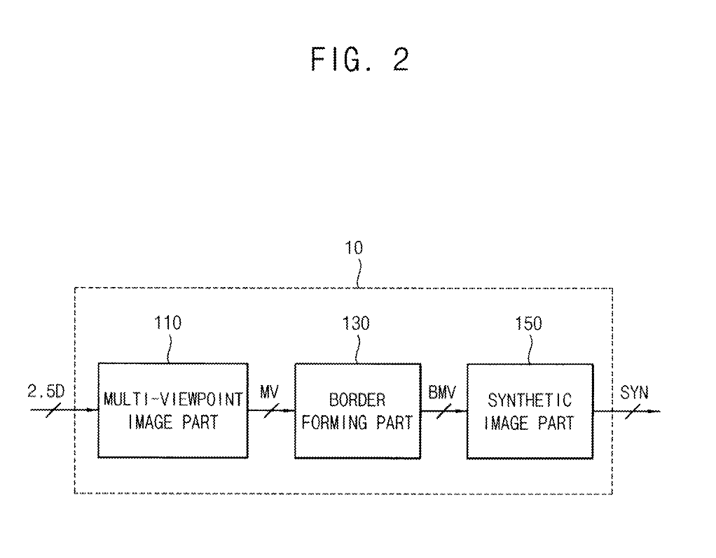

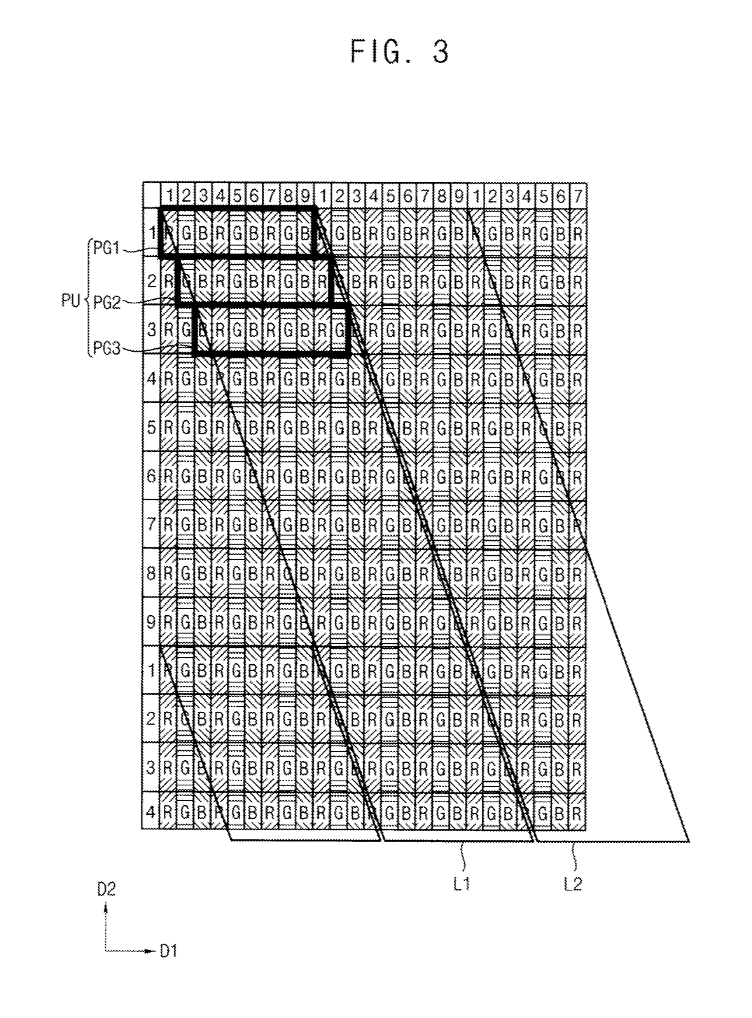

FIG. 1 is a block diagram illustrating a stereo-scopic image display apparatus according to an exemplary embodiment of the present invention. FIG. 2 is a block diagram illustrating of a stereo-scopic image converting apparatus of FIG. 1. FIG. 3 is a conceptual diagram illustrating exemplary correspondence between the pixels and the lenticular lens of FIG. 1.

Referring to FIGS. 1 and 2, a stereo-scopic image display apparatus 1 includes a stereo-scopic image converting apparatus 10, a control part 30, a display driving part 50, a light source driving part 70, a display panel 20, a lens part 40 and a light source part 60.

The stereo-scopic image converting apparatus 10 converts a two-dimensional image and a depth image 2.5D of the two-dimensional image provided from an external apparatus into a synthetic image SYN so as to display a stereo-scopic image on the display panel 20. The synthetic image SYN is displayed in a display region DA of the display panel 20 and may be perceived as a stereo-scopic image through the lens part 40.

The stereo-scopic image converting apparatus 10 includes a multi-viewpoint image part 110, a border forming part 130 and a synthetic image part 150. The stereo-scopic image converting apparatus 10 and the control part 30 may be formed on the same substrate or on respective separate substrates.

The multi-viewpoint image part 110 generates a plurality of multi-viewpoint images MV based on the two-dimensional image and the depth image 2.5D. The number of viewpoints of the stereo-scopic image display apparatus 1 is a natural number greater than or equal to 2. The stereo-scopic image display apparatus 1 according to a present exemplary embodiment may display a 9-viewpoint image. For simplicity, a 9-viewpoint image will be described below. It is to be understood, however, that this number of viewpoints is exemplary and non-limiting, and more or fewer viewpoints are within the scope of other embodiments of the invention. From a viewer's perspective, viewpoints according to a present embodiment of the invention may be defined from right to left as a first, second, third, fourth, fifth, sixth, seventh, eighth and ninth viewpoint.

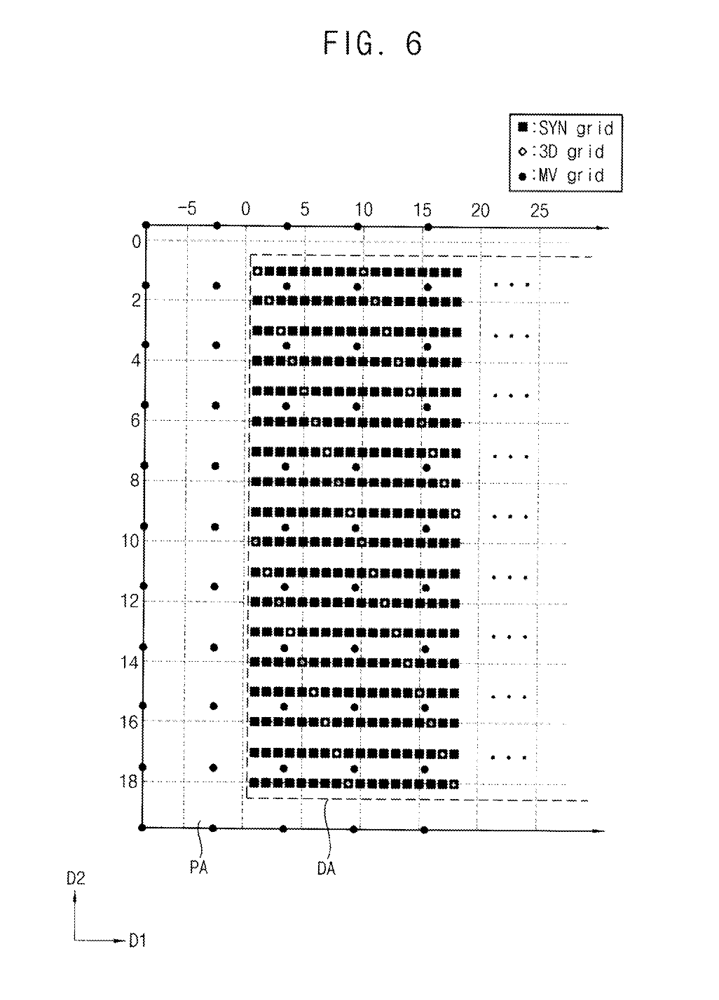

The multi-viewpoint images MV includes image values in a multi-viewpoint image grid, shown in FIG. 6, corresponding to the display region DA. Positions of nine pixels overlap with each other at the multi-viewpoint image grid, and the image value at each of the multi-viewpoint image grid points includes image information for the nine pixels. The multi-viewpoint images MV generated from the multi-viewpoint image part 110 are provided to the border forming part 130.

The border forming part 130 forms an imaginary border around each of the multi-viewpoint images MV. The border may be formed by setting to black the image values for the multi-viewpoint image grid points that border the display region DA. The border may correspond to a peripheral region PA surrounding the display region DA or may correspond to one or two pixels P inside from the edges of the display region DA. The border forming part 130 provides to the synthetic image part 150 the multi-viewpoint images BMV in which the border is formed.

The synthetic image part 150 converts the multi-viewpoint images BMV provided from the border forming part 130 in which the border is formed into a synthetic image SYN. The multi-viewpoint images BMV in which the border is formed may be referred to herein below as bordered multi-viewpoint images. The synthetic image SYN includes image values in a synthetic image grid, shown in FIG. 6, corresponding to the display region DA.

The synthetic image part 150 interpolates the image values in the synthetic image grid using the image values in the multi-viewpoint image grid. The synthetic image part 150 provides the synthetic image SYN to the control part 30.

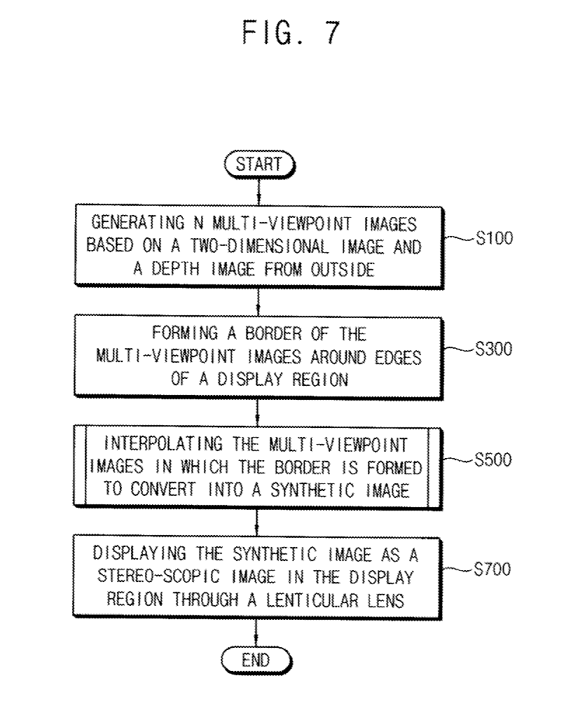

A process for generating the multi-viewpoint images MV in the multi-viewpoint image part 110, a process for generating the border of the multi-viewpoint images MV in the border forming part 130 and a process for generating the synthetic image SYN in the synthetic image part 150 will be described in detail below in connection with FIGS. 7-9.

Alternatively, the stereo-scopic image converting apparatus 10 may directly receive the multi-viewpoint images MV from an external apparatus. When the stereo-scopic image converting apparatus 10 receives the multi-viewpoint images MV, the multi-viewpoint image part 110 may be omitted.

The control part 30 controls a driving of the stereo-scopic image display apparatus 1. The control part 30 provides to the display driving part 50 and the light source driving part 70 the synthetic image SYN received from the stereo-scopic image converting apparatus 10 and first and second control signals CS1 and CS2 derived from a control signal CS received from outside.

The light source driving part 70 generates a first driving signal DS1 for driving the light source part 60 based on a first control signal CS1 received from the control part 30.

The light source part 60 includes a light source generating light. The light source part 60 is disposed on a rear surface of the display panel 20 and provides light to the display panel 20. The light source part 60 may be a direct illumination type in which the light source is disposed under the display panel 20, or an edge illumination type in which the light source is disposed at an edge of the display panel 20. The light source may include a lamp or a light emitting diode.

The display driving part 50 generates a second driving signal DS2 for driving the display panel 20 based on a second control signal CS2 received from the control part 30. The display driving part 50 includes a gate driving part and a data driving part.

The data driving part provides a data voltage to the pixel P and the gate driving part provides a gate signal that controls timing during which the data voltage is charged to the pixel P. The gate driving part may be mounted on the display panel 20 as a chip or may be directly formed on the display panel 20 during processes for forming a thin-film transistor.

The display panel 20 displays the synthetic image SYN based on the second driving signal DS2 received from the display driving part 50. The display panel 20 displays the synthetic image SYN as a stereo-scopic image through the lens part 40.

The display panel 20 includes a display region DA displaying the stereo-scopic image and a peripheral region PA surrounding the display region DA. For example, the display panel 20 may have a rectangular shape, and have a longer side substantially parallel to a first direction D1 and a shorter side substantially parallel to a second direction D2 substantially perpendicular to the first direction D1. However, the shape of the display panel 20 may vary, and may have the shorter side substantially parallel to the first direction D1 and the longer side substantially parallel to the second direction D2, or may be square.

The display panel 20 includes red R, green G and blue B pixels P that are disposed in a matrix pattern. A black matrix may be formed between the pixels P. As shown in FIG. 3, the red R, the green G and the blue B pixels P alternate in the first direction D1, with pixels P having the same color forming columns in the second direction D2.

The pixel P may be rectangular in shape, and have a shorter side substantially parallel with the first direction D1 and a longer side substantially parallel with the second direction D2. For example, an aspect ratio of the shorter side to the longer side of the pixel P may be about 1:3.

The lens part 40 includes a plurality of lenticular lenses L1 and L2 disposed on the display panel 20 having lens axes Ax substantially parallel with each other. The lens axis Ax of the lenticular lenses L1 and L2 may be substantially parallel to the second direction D2 or may be inclined by a tilt angle θ with respect to the second direction D2.

For example, when viewed on a plane, the lenticular lenses L1 and L2 may form parallelograms that are inclined by the tilt angle θ with respect to the second direction D2. When the lens axis Ax of the lenticular lenses L1 and L2 is inclined, moire patterns displayed at a particular viewpoint that result from the black matrix formed between the pixels P may be decreased.

To display a 9-viewpoint image on the stereo-scopic image display apparatus 1, the lenticular lenses L1 and L2, each corresponding to the nine pixels P, may be repeatedly formed on the display panel 20 in the first direction D1, as shown FIG. 3. In this case, the tilt angle θ may be defined as tan⁻¹ ((length of the longer side of the pixel P)/(length of the shorter side of the pixel P)). The black matrix formed between the pixels P is omitted in FIG. 3, for convenience.

Nine pixels P formed in a row on the display panel 20 in the first direction D1 may be defined as a pixel group PG1 of the stereo-scopic image corresponding to nine viewpoints, respectively. Pixel group PG2 may be formed on the row below pixel group PG1 and be offset by one pixel in the D1 direction, and pixel group PG3 may be formed on the row below pixel group PG2 offset by one pixel in the D1 direction. A pixel unit PU of the stereo-scopic image includes three pixel groups PG1, PG2 and PG3 of the stereo-scopic image. Thus, the pixel unit PU may have nine pixels P respectively corresponding to nine viewpoints in the first direction D1, and three pixels P respectively corresponding to the red R, green G and blue B in the second direction D2. When the pixel groups PG1, PG2 and PG3 of the stereo-scopic image SYN are displayed in the display panel 20, nine stereo-scopic images having different directions are transmitted through the lenticular lenses L1 and L2.

The lenticular lenses L1 and L2 are not parallel with the pixel groups PG1, PG2 and PG3, so a serrated border may appear while displaying the stereo-scopic image in the display region DA.

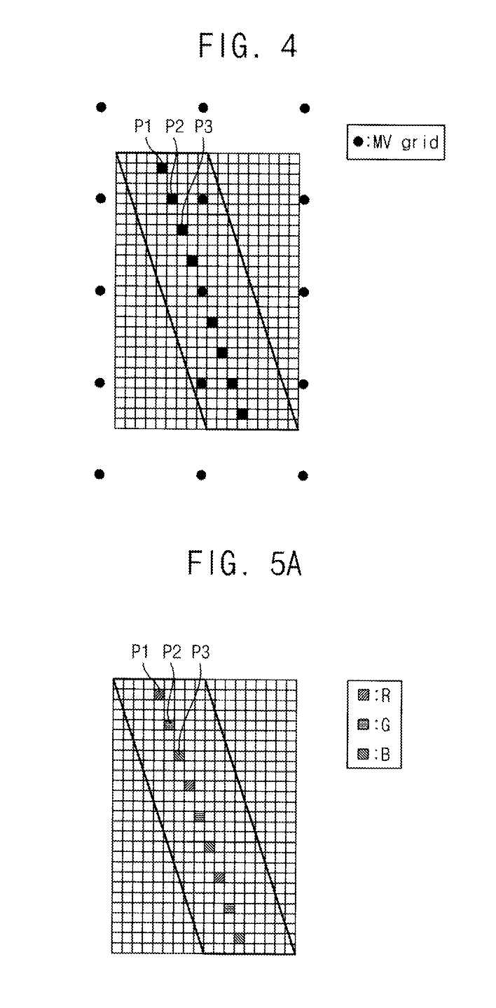

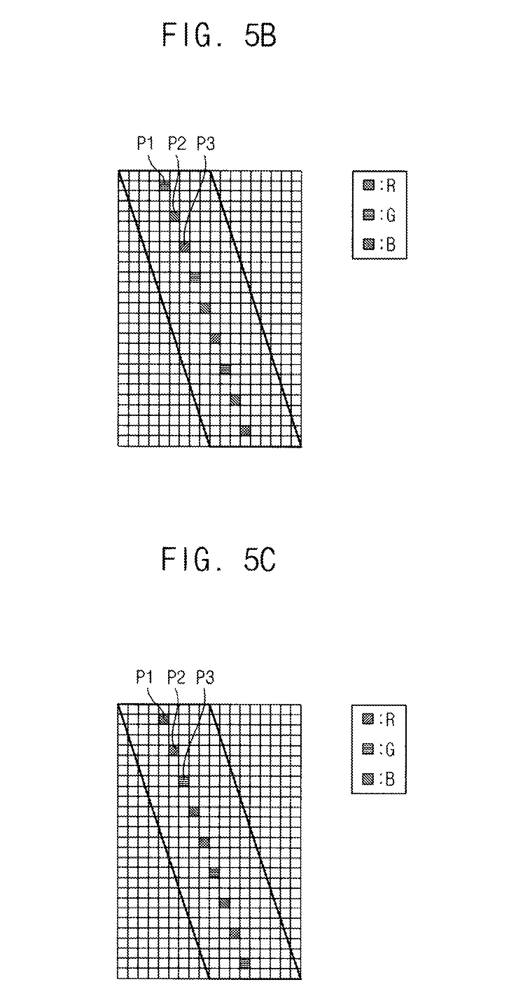

FIG. 4 is a conceptual diagram illustrating an exemplary multi-viewpoint image of FIG. 3. FIGS. 5A to 5C are conceptual diagrams illustrating pixels shown at each viewpoint, when the multi-viewpoint image of FIG. 4 is displayed.

Referring to FIGS. 4 to 5C, a relationship between the multi-viewpoint image MV generated from the multi-viewpoint image part 110 and each viewpoint may be known. To display the 9-viewpoint image, the multi-viewpoint image part 110 generates the images values in the multi-viewpoint image grid. The positions of the nine pixels P overlap with each other at each of the multi-viewpoint image grid points, and each image value at each multi-viewpoint image grid point includes image information on nine pixels P.

When the multi-viewpoint image MV of FIG. 4 is displayed, a first position P1, a second position P2 and a third position P3 may respectively display the red R, the green G and the blue B pixels P at a first viewpoint, a fourth viewpoint and a seventh viewpoint, as shown in FIG. 5A. Alternatively, the first position P1, the second position P2 and the third position P3 may respectively display the green G, the blue B and the red R pixels P at a second viewpoint, a fifth viewpoint and a eighth viewpoint, as shown in FIG. 5B. In addition, the first position P1, the second position P2 and the third position P3 may respectively display the blue B, the red R and the green G pixels P at a third viewpoint, a sixth viewpoint and a ninth viewpoint, as shown in FIG. 5C.

FIG. 6 is a conceptual diagram illustrating a multi-viewpoint image grid of a multi-viewpoint image and a synthetic image grid of a synthetic image of FIG. 3. Referring to FIG. 6, points on the synthetic image grid are indicated by the SYN grid label, points in a 3D stereo-scopic image grid are indicated by the 3D grid label, and points in the multi-viewpoint image grid are indicated by the MV grid label.

The multi-viewpoint image part 110 outputs the image values in the multi-viewpoint image grid corresponding to the display region DA, and the synthetic image part 150 outputs the image values in the synthetic image grid.

A 3D stereo-scopic image grid of FIG. 6 corresponds to central positions of each of the pixel groups PG1, PG2 and PG3 of the stereo-scopic image, when the synthetic image SYN is displayed as the stereo-scopic image through the lens part 40. As shown in FIG. 6, positions of the multi-viewpoint image grid are different from positions of the 3D stereo-scopic image grid 3D grid, so that the image values in the synthetic image grid may be calculated using interpolation.

The border forming part 130 forms an imaginary border around each of the multi-viewpoint images MV. The border may be formed by setting to black the image values in the multi-viewpoint image grid points that border the display region DA. The border may correspond to the peripheral region PA surrounding the display region DA or may correspond to one or two pixels P inside from the edges of the display region DA.

For example, the border forming part 130 may set to black the image values in the multi-viewpoint image grid corresponding to the peripheral region PA. In this case, the border of the multi-viewpoint images MV may extend outside of the display region DA.

Alternatively, the border forming part 130 may set to black the image values in the multi-viewpoint image grid corresponding to one or two pixels P inside from the edges of the display region DA.

Alternatively, the border forming part 130 may set to black the image values in the multi-viewpoint image grid corresponding to the peripheral region PA and one or two pixels P inside from the edges of the display region DA. An exemplary, non-limiting a value corresponding to black may be 0.

The border forming part 130 provides to the synthetic image part 150 the multi-viewpoint images BMV in which the border is formed. The multi-viewpoint images MV in which the border is formed are referred to herein below as bordered multi-viewpoint images. The synthetic image part 150 interpolates the image values in the synthetic image grid using the bordered multi-viewpoint images BMV. Thus, the serrated border due to the pixel groups PG1, PG2 and PG3 not being parallel to the lenticular lenses L1 and L2 may be shown as black, to improve display quality.

The synthetic image part 150 may interpolate image values in the synthetic image grid using four image values in the multi-viewpoint image grid nearest to the synthetic image grid point.

To use a bicubic interpolation method, a conversion scale and a conversion offset of the synthetic image SYN are calculated first. A row conversion scale and a column conversion scale of the synthetic image SYN may be respectively defined by the following Equations 1 and 2.

−row_conversion_scale=number_of_rows_of_multi_viewpoint_image_grid/number_of_rows_of_synthetic_image_grid Equation 1

column_conversion_scale=number_of_columns_of_multi_viewpoint_image_grid/number_of_columns_of synthetic_image_grid Equation 2

In addition, a row conversion offset and a column conversion offset of the synthetic image SYN may be respectively defined by the following Equations 3 and 4.

row_conversion_offset={1−row_conversion scale}/2 Equation 3

column_conversion_offset={1−column_conversion_{—} scale}/2 Equation 4

Then, a color number and a viewpoint number in the synthetic image grid are calculated. The color number and the viewpoint number in the synthetic image grid may be respectively defined by the following Equations 5 and 6.

color_number=mod{column_number−1, 3}+1 Equation 5

viewpoint_number=mod {column_number—a_row_number+viewpoint_offset, number_of_viewpoints}+1 Equation 6

Here, mod{a, b} is a remainder from dividing ‘a’ by ‘b’, and the viewpoint offset is an integer between 1 and the number of the viewpoints

Then, a displacement of the synthetic image SYN is calculated from the conversion scale and the conversion offset of the synthetic image SYN. First, for calculating a row displacement and a column displacement of the synthetic image SYN, a row position and a column position of the synthetic image SYN are calculated. The row position and the column position of the synthetic image SYN may be respectively defined by the following Equations 7 and 8.

row_position=row number×row_conversion_scale+row_conversion_offset Equation 7

column_position=column_number×column_conversion_scale+column_conversion_offset Equation 8

The row displacement and the column displacement of the synthetic image SYN are calculated using the row position and the column position of the synthetic image SYN, respectively. The row displacement and the column displacement may be respectively defined by the following Equations 9 and 10.

row_displacement=row_position—floor{row_position} Equation 9

column_displacement=column_position—floor{column_position} Equation 10

Here, floor{c} is the truncation of all decimal digits of ‘c’.

The multi-viewpoint image part 110 may interpolate the image values in the synthetic image grid based on the displacement of the synthetic image SYN, and the color number and the viewpoint number in the synthetic image grid. The interpolation may be a conventional interpolation method such as bilinear interpolation or bicubic interpolation.

The multi-viewpoint image part 110 may effectively calculate the image values in the synthetic image grid by interpolation, to decrease the load of calculations.

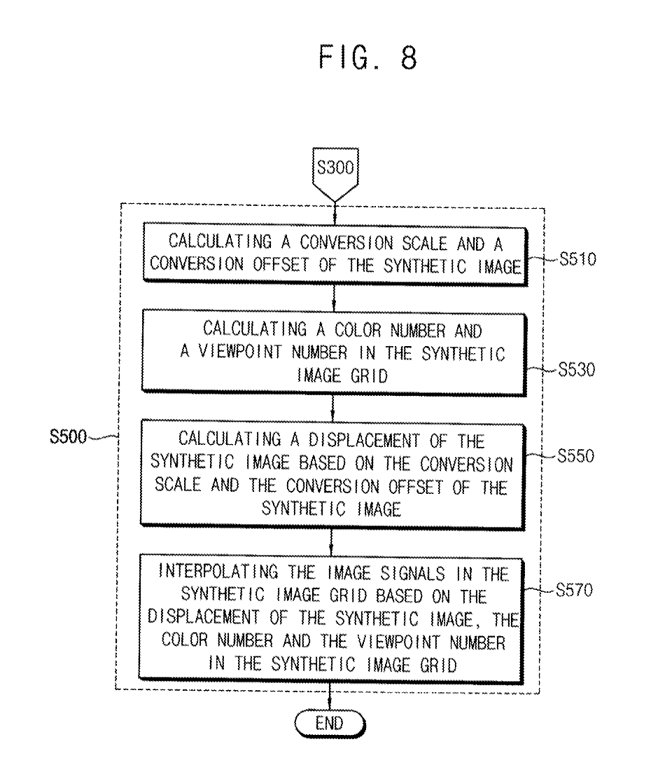

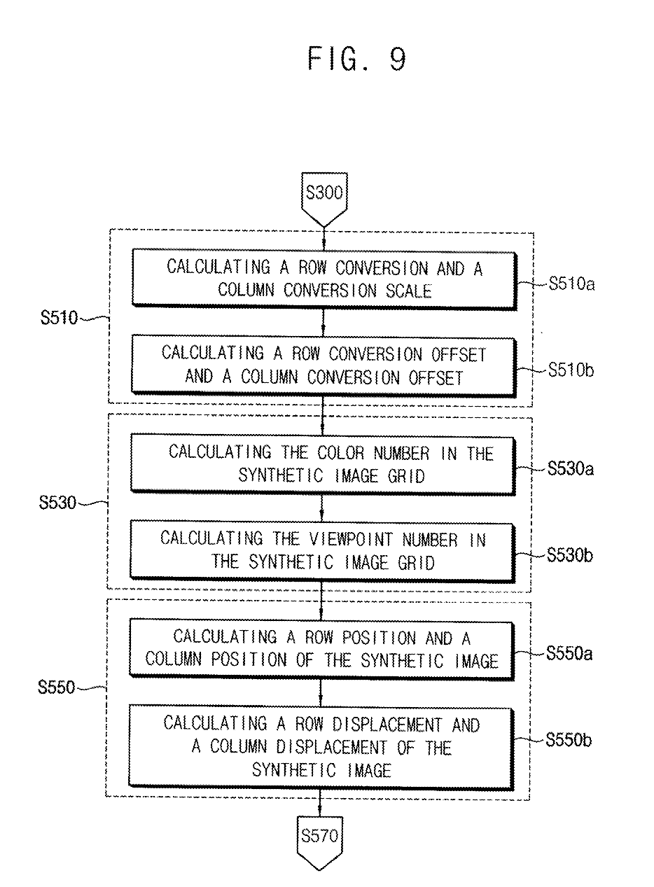

FIG. 7 is a flow chart illustrating a method for displaying a stereo-scopic image performed by a stereo-scopic image display apparatus of FIG. 1. FIGS. 8 and 9 are detailed flow charts illustrating the FIG. 7 steps of interpolating the multi-viewpoint images to convert them into the synthetic image.

Referring to FIG. 7, at step S100, the multi-viewpoint image part 110 generates a plurality of multi-viewpoint images MV based on the two-dimensional image and the depth image 2.5D.

The viewpoint number of the stereo-scopic image display apparatus 1 is a natural number greater than or equal to 2. A stereo-scopic image display apparatus 1 according to a present exemplary embodiment may display a 9-viewpoint image. From a viewer's perspective, viewpoints may be defined from right to left as a first, second, third, fourth, fifth, sixth, seventh, eighth and ninth viewpoints.

The multi-viewpoint images MV include the image values in the multi-viewpoint image grid corresponding to the display region DA. The positions of nine pixels overlap with each other at the multi-viewpoint image grid, and the image value at each of the multi-viewpoint image grid points includes image information for the nine pixels. The multi-viewpoint images MV generated from the multi-viewpoint image part 110 are provided to the border forming part 130.

At step S300, the border forming part 130 forms a border for each of the multi-viewpoint images MV around edges of the display region DA, and provides the bordered multi-viewpoint images BMV to the synthetic image part 150.

The border forming part 130 forms a border for each of the multi-viewpoint images MV. The border may be formed by setting to black the image values in the multi-viewpoint image grid around the edges of the display region DA. The border may correspond to the peripheral region PA surrounding the display region DA or may correspond to one or two pixels P inside from the edges of the display region DA.

For example, the border forming part 130 may set to black the image values in the multi-viewpoint image grid corresponding to the peripheral region PA In this case, the border of the multi-viewpoint images MV may extend outside of the display region DA.

Alternatively, the border forming part 130 may set to black the image values in the multi-viewpoint image grid corresponding to one or two pixels P inside from the edges of the display region DA.

Alternatively, the border forming part 130 may set to black the image values in the multi-viewpoint image grid corresponding to the peripheral region PA and one or two pixels P inside from the edges of the display region DA. An exemplary, non-limiting black value may be 0.

At step S500, the synthetic image part 150 converts the bordered multi-viewpoint images BMV received from the border forming part 130 into the synthetic image SYN.

The synthetic image part 150 interpolates image values in the synthetic image grid using the image values in the multi-viewpoint image grid MV.

The synthetic image part 150 may interpolate image values in the synthetic image grid using four image values in the multi-viewpoint image grid nearest to the synthetic image grid point.

Referring to FIGS. 8 and 9, which illustrate the calculation of the image value in the synthetic image grid, the conversion scale and the conversion offset of the synthetic image SYN are calculated first at step S510. At step S510a, the row conversion scale and the column conversion scale of the synthetic image SYN may be respectively defined by Equations 1 and 2, above. In addition, at step S510b, the row conversion offset and the column conversion offset of the synthetic image SYN may be respectively defined by Equations 3 and 4, above.

Then, at step S530, the color number and the viewpoint number in the synthetic image grid are calculated. The color number and the viewpoint number in the synthetic image grid may be respectively defined by Equations 5 and 6, above, at step S530a and step S530b.

Then, at step S550, the displacement of the synthetic image SYN is calculated based on the conversion scale and the conversion offset of the synthetic image SYN. First, at step S550a, to calculate the row displacement and the column displacement of the synthetic image SYN, the row position and the column position of the synthetic image SYN are calculated. The row position and the column position of the synthetic image SYN may be respectively defined by Equations 7 and 8, above. Next, at step S550b, the row displacement and the column displacement of the synthetic image SYN are calculated using the row position and the column position of the synthetic image SYN, respectively. The row displacement and the column displacement may be respectively defined by Equations 9 and 10, above.

At step S570, the image values in the synthetic image grid may be interpolated based on the displacement of the synthetic image SYN, and the color number and the viewpoint number in the synthetic image grid. The interpolation may be a conventional interpolation method such as bilinear interpolation or bicubic interpolation.

When using a method for displaying the stereo-scopic image, the image values in the synthetic image grid may be effectively calculated by interpolation, to decrease the load of calculations.

At step S700, the synthetic image SYN is displayed as a stereo-scopic image in the display region DA through the inclined lens part 40. The synthetic image SYN is converted from the bordered multi-viewpoint images BMV, which can decrease the serrated border of the stereo-scopic image.

As described above, a method for displaying the stereo-scopic image according to an embodiment of the present invention uses interpolation, to reduce the number of calculations for converting the two-dimensional image into the stereo-scopic image. In addition, a border is formed in the multi-viewpoint image, which may be converted into the stereo-scopic image, decreasing the serrated border of the stereo-scopic image and improving display quality.

The foregoing is illustrative of embodiments of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the embodiments of the present invention. Therefore, it is to be understood that the foregoing is illustrative of the present invention and is not to be construed as limited to specific exemplary embodiments disclosed, and that modifications to the disclosed exemplary embodiments, as well as other exemplary embodiments, are intended to be included within the scope of the appended claims. Embodiments of the present invention are defined by the following claims, with equivalents of the claims to be included therein.

What is claimed is:

1. A method for converting a two-dimensional image into a stereo-scopic image, the method comprising:
forming for each of a plurality of multi-viewpoint images a border around an edge of a display region; and
converting the plurality of bordered multi-viewpoint images into a synthetic image.

2. The method of claim 1, further comprising generating the plurality of the multi-viewpoint images based on a two-dimensional image and a depth image.

3. The method of claim 2, wherein generating the plurality of multi-viewpoint images comprises:
generating image values in a multi-viewpoint image grid corresponding to the display region.

4. The method of claim 3, wherein forming the border for each of the plurality of multi-viewpoint images comprises:
setting to black the image values in the multi-viewpoint image grid corresponding to a peripheral region surrounding the display region.

5. The method of claim 4, wherein forming the border for each of the plurality of multi-viewpoint images further comprises:
setting to black the image values in the multi-viewpoint image grid corresponding to one or two pixels inside from the edges of the display region.

6. The method of claim 3, wherein forming the border for each of the plurality of multi-viewpoint images comprises:
setting to black the image values in the multi-viewpoint image grid corresponding to one or two pixels inside from the edges of the display region.

7. The method of claim 3, wherein converting the plurality of bordered multi-viewpoint images into the synthetic image comprises:
interpolating image values in a synthetic image grid using four nearest image values in the multi-viewpoint image grid.

8. The method of claim 7, wherein interpolating the image values in the synthetic image grid comprises:
calculating a conversion scale and a conversion offset of the synthetic image;
calculating a color number and a viewpoint number in the synthetic image grid;
calculating a displacement of the synthetic image based on the conversion scale and the conversion offset of the synthetic image; and
interpolating the image values in the synthetic image grid based on the displacement of the synthetic image, the color number and the viewpoint number in the synthetic image grid.

9. The method of claim 8, wherein calculating the conversion scale and the conversion offset of the synthetic image comprises:
calculating a row conversion scale according to
row_conversion_scale=number_of_rows_of multi_viewpoint_image_grid/number_of_rows_of_synthetic_image_grid;
a column conversion scale according to
column_conversion_scale=number_of_columns_of_multi_viewpoint_image_grid/number_of_columns_of_synthetic_image_grid;
calculating a row conversion offset according to
row_conversion_offset={1−row_conversion_scale}/2;
and
a column conversion offset according to
column_conversion_offset={1−column_conversion_scale}/2.

10. The method of claim 9, wherein calculating the color number and the viewpoint number in the synthetic image grid comprises:
calculating the color number according to
color_number=mod{column_number−1, 3}+1; and
calculating the viewpoint number according to
viewpoint_number=mod{column_number—row_number+viewpoint_offset, number_of_viewpoints}+1,
wherein
mod{a, b} represents a remainder of dividing ‘a’ by ‘b’ and viewpoint offset is an integer between 1 and the number of the viewpoints.

11. The method of claim 10, wherein calculating the displacement of the synthetic image based on the conversion scale and the conversion offset of the synthetic image comprises:
calculating a row position according to
row_position=row_number×row_conversion_scale+row_conversion_offset;
a column position according to
column_position=column_number×column_conversion_scale+column_conversion_offset;
calculating a row displacement using the row position according to
row_displacement=row_position−floor{row_position}; and
a column displacement using the column position according to
column_displacement=column_position−floor{column_position},
wherein floor{c} represents a truncation of all decimal digits of ‘c’.

12. The method of claim 7, wherein the multi-viewpoint images are interpolated using one of bilinear interpolation or bicubic interpolation.

13. A method for displaying a stereo-scopic image, the method comprising:
interpolating a plurality of image values using four nearest image values in a multi-viewpoint image grid to generate a synthetic image grid; and
displaying the synthetic image as a stereo-scopic image in a display region through a lenticular lens inclined by a predetermined angle with respect to a display panel.

14. The method of claim 13, further comprising generating the plurality of image values in the multi-viewpoint image grid corresponding to the display region based on a two-dimensional image and a depth image.

15. The method of claim 13, wherein interpolating the image values in the synthetic image grid comprises:
calculating a conversion scale and a conversion offset of the synthetic image;
calculating a color number and a viewpoint number in the synthetic image grid;
calculating a displacement of the synthetic image based on the conversion scale and the conversion offset of the synthetic image; and
interpolating the image values in the synthetic image grid based on the displacement of the synthetic image, the color number and the viewpoint number in the synthetic image grid.

16. The method of claim 13, further comprising forming, for each of the plurality of multi-viewpoint images, a border around an edge of the display region.

17. The method of claim 16, wherein forming the border for each of the plurality of multi-viewpoint images comprises one or more of setting to black the image values in the multi-viewpoint image grid corresponding to a peripheral region surrounding the display region, and setting to black the image values in the multi-viewpoint image grid corresponding to one or two pixels inside from the edges of the display region.

18. A stereo-scopic image display apparatus comprising:
a border forming part for forming, for each of a plurality of multi-viewpoint images, a border around an edge of a display region;
a synthetic image part for converting the plurality of bordered multi-viewpoint images into a synthetic image; and
a display panel for displaying the synthetic image as a stereo-scopic image in the display region through a lenticular lens inclined by a predetermined angle.

19. The apparatus of claim 18, further comprising a multi-viewpoint image part for generating the plurality of the multi-viewpoint images based on a two-dimensional image and a depth image.

20. The apparatus of claim 18, wherein the lenticular lens has a parallelogram shape in which a pair of sides facing each other are substantially parallel with a side of the display panel.

21. The apparatus of claim 20, wherein a width of the lenticular lens corresponds to a predetermined number of pixels of the display panel, each pixel corresponding to one of the plurality of multi-viewpoint images, and a plurality of the lenticular lenses are arranged along the side of the display panel.

22. The apparatus of claim 18, wherein the border forming part sets to black the image values in the multi-viewpoint image grid corresponding to a peripheral region surrounding the display region.

23. The apparatus of claim 18, wherein the border forming part sets to black the image values in the multi-viewpoint image grid corresponding to one or two pixels inside from the edges of the display region.

24. A stereo-scopic image display apparatus comprising:
a synthetic image part for interpolating a plurality of image values using four nearest image values in a multi-viewpoint image grid to generate a synthetic image grid; and
a display panel for displaying the synthetic image as a stereo-scopic image in a display region through a lenticular lens inclined by a predetermined angle,
wherein a width of the lenticular lens corresponds to a predetermined number of pixels of the display panel, each pixel corresponding to one of the plurality of multi-viewpoint images, and a plurality of the lenticular lenses are arranged along the side of the display panel.

25. The stereo-scopic image display apparatus of claim 24, further comprising a multi-viewpoint image part for generating the plurality of the image values in the multi-viewpoint image grid corresponding to the display region based on a two-dimensional image and a depth image.

26. The stereo-scopic image display apparatus of claim 24, further comprising a border forming part for forming, for each of the plurality of multi-viewpoint images, a border around an edge of the display region.
